(19) United States
(12) Patent Application Publication
(10) Pub. No.: US 2024/0342650 A1
(43) Pub. Date: Oct. 17, 2024

(54) METHOD FOR RECOVERING GERMANIUM

(71) Applicant: SUMITOMO ELECTRIC INDUSTRIES, LTD., Osaka (JP)

(72) Inventors: Kiichi KIMURA, Osaka (JP); Toshimi HABASAKI, Tochigi (JP)

(21) Appl. No.: 18/755,796

(22) Filed: Jun. 27, 2024

(30) Foreign Application Priority Data
Jul. 10, 2023 (JP) 2023-112888

(51) Int. Cl. B01D 53/64; B01D 53/04; C03B 37/014

(52) U.S. Cl. CPC B01D 53/64; B01D 53/0462; C03B 37/0144; B01D 2257/55

(57) ABSTRACT

A method for recovering germanium from exhaust gas in a manufacturing step of an optical fiber preform, the method includes: a first step of allowing the exhaust gas to pass through a separation device and separating germanium from the exhaust gas. The exhaust gas is gas exhausted in a dehydration and consolidation step of optical fiber preform manufacturing.

### TECHNICAL FIELD

The present disclosure relates to a method for recovering germanium. This application claims priority based on Japanese Patent Application No. 2023-112888 filed on Jul. 10, 2023, and the entire contents of which are incorporated herein by reference.

### BACKGROUND ART

Germanium is used as a raw material of various industrial products, for example, a semiconductor material of a diode or the like or an additive of a core in a glass optical fiber. Recently, the price of germanium has suddenly increased. Accordingly, for example, JPS58-213838A, JP2004-2088A and JP2017-140571A disclose techniques for recovering germanium. JPS58-213838A discloses a technique in which germanium oxide volatilized in a dehydration and consolidation step during transparent vitrification is recovered as metal germanium using a reducing agent. JP2004-2088A discloses a technique in which germanium-containing particles are recovered by a bag filter in a deposition step of a porous preform and is reused in an optical fiber manufacturing step. JP2017-140571A discloses a technique in which, in a wastewater treatment step, chelate-forming fibers are brought into contact with a germanium-containing aqueous solution where the pH is adjusted to 3 or more and 12 or less to remove and recover germanium in the aqueous solution.

### SUMMARY

According to the present disclosure, there is provided a method for recovering germanium from exhaust gas in a manufacturing step of an optical fiber preform, the method including:
a first step of allowing the exhaust gas to pass through a separation device and separating germanium from the exhaust gas,
in which the exhaust gas is gas exhausted in a dehydration and consolidation step of optical fiber preform manufacturing.

### BRIEF DESCRIPTION OF DRAWINGS

FIG. 1 is a diagram illustrating a flow of a method for recovering germanium according to one embodiment of the present disclosure.

FIG. 2 is a diagram schematically illustrating a first step according to a first aspect of the embodiment of the present disclosure.

FIG. 3 is a diagram schematically illustrating a first step and a second step according to a second aspect of the embodiment of the present disclosure.

FIG. 4 is a diagram schematically illustrating an example of a germanium extraction liquid treatment step.

FIG. 5 is a diagram schematically illustrating another example of the germanium extraction liquid treatment step.

### DESCRIPTION OF EMBODIMENTS

When an optical fiber is manufactured, a part of germanium that is an additive of a core of the optical fiber is exhausted together with exhaust gas. Germanium in the exhaust gas is treated in an exhaust gas treatment and discharged water treatment step of the subsequent stage and is finally exhausted as sludge together with silicon oxide. The techniques of recovering germanium in each of the steps of manufacturing an optical fiber have been disclosed. However, it is not easy to efficiently and inexpensively recover germanium. In JPS58-213838A, carbon is used as the reducing agent, and thus toxic carbon monoxide is produced. In JP2004-2088A, the amount of treated gas is large, and the size of the facility is large. In the method using the chelate-forming fiber disclosed in JP2017-140571A, the facility is expensive.

An object of the present disclosure is to provide a germanium recovery method capable of efficiently and inexpensively recovering germanium when an optical fiber is manufactured.

According to the present disclosure, a germanium recovery method capable of efficiently and inexpensively recovering germanium when an optical fiber is manufactured can be provided.

### DESCRIPTION OF EMBODIMENT OF PRESENT DISCLOSURE

First, embodiments of the present disclosure will be described. A method for recovering germanium according to one embodiment of the present disclosure is
(1) a method for recovering germanium from exhaust gas in a manufacturing step of an optical fiber preform, the method including:
a first step of allowing the exhaust gas to pass through a separation device and separating germanium from the exhaust gas,
in which the exhaust gas is gas exhausted in a dehydration and consolidation step of optical fiber preform manufacturing.

In the above-described germanium recovery method, germanium can be recovered by a small and inexpensive recovery facility.
(2) The method for recovering germanium according to (1),
in which the separation device may be a wet collection device, and
in the first step, the exhaust gas may be allowed to pass through the wet collection device to extract germanium into a liquid.

By adopting the wet collection device as the separation device, germanium can be recovered even when the exhaust gas includes dehydration gas such as chlorine gas.
(3) The method for recovering germanium according to (2),
in which a temperature of the liquid used for extracting the germanium may be 30° C. or higher and 80° C. or lower.

By adjusting the temperature of the liquid, the concentration of germanium in the liquid can be increased, and costs such as a transport cost or a regeneration cost for reusing the recovered germanium can be reduced.
(4) The method for recovering germanium according to (1),
in which the separation device may be a dry adsorption device including an adsorbent,
in the first step, the germanium may be adsorbed to the adsorbent, and
the method for recovering germanium may further include a second step of extracting the germanium adsorbed to the adsorbent into a liquid after the first step.

By adopting the dry adsorption device as the separation device, the degree of freedom of the facility increases, and the operation is simple.
(5) The method for recovering germanium according to (4),
in which in the second step, at least one of a pH and a temperature of the liquid may be adjusted, and germanium may be extracted into the liquid.

By adjusting the pH or the temperature of the liquid, germanium can be efficiently extracted into the liquid at a low cost.
(6) The method for recovering germanium according to (5),
in which in the second step, the pH of the liquid may be adjusted to be 0 or more and 6 or less.

By adjusting the liquid to be acidic, germanium can be efficiently extracted.
(7) The method for recovering germanium according to (5) or (6),
in which in the second step, the temperature of the liquid used for extracting the germanium may be 30° C. or higher and 80° C. or lower.

By adjusting the temperature of the liquid, the concentration of germanium in the liquid can be increased, and costs such as a transport cost or a regeneration cost for reusing the recovered germanium can be reduced.

### DETAILS OF EMBODIMENT OF PRESENT DISCLOSURE

Hereinafter, a specific example of a method for recovering germanium according to the present disclosure will be described with reference to the drawings. The present invention is not limited to these examples and is intended to include any modifications within the scope and meaning equivalent to the terms of the claims.

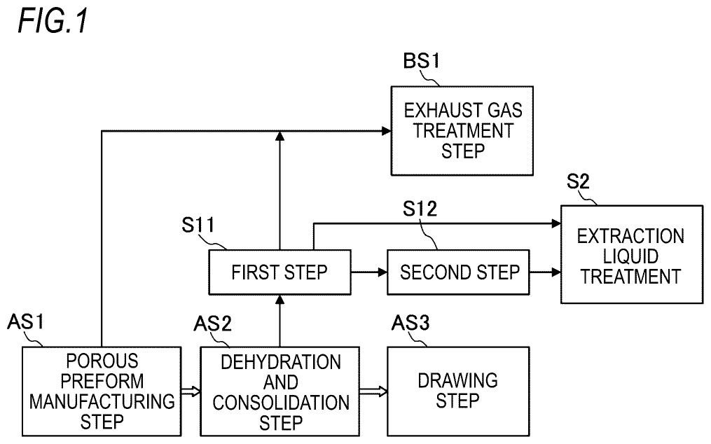

FIG. 1 is a diagram illustrating flows of manufacturing steps of an optical fiber and the method for recovering germanium according to the present embodiment. The manufacturing steps of an optical fiber includes a porous preform manufacturing step AS1, a dehydration and consolidation step AS2, and a drawing step AS3. The method for recovering germanium according to the present embodiment includes a first step S11 of separating germanium from exhaust gas exhausted from a furnace tube in the dehydration and consolidation step AS2.

The porous preform manufacturing step AS1 is a step of manufacturing a porous glass preform for an optical fiber using an OVD method, a VAD method, or the like. A major component of the porous preform is silica, and germanium is added to a core.

Next, the porous preform obtained in the porous preform manufacturing step AS1 is dehydrated and made transparent in the dehydration and consolidation step AS2. In the dehydration and consolidation step AS2, first, the porous preform is dehydrated using gas having a dehydration action such as chlorine gas, and subsequently the porous preform is consolidated to be transparent using helium gas or the like. As a result, an optical fiber preform is obtained.

Next, the optical fiber preform that is made transparent in the dehydration and consolidation step AS2 is drawn in the drawing step AS3. By drawing the optical fiber preform, an optical fiber as a product can be obtained.

As described above, germanium is added as an additive to the porous preform. However, a part of germanium supplied in the porous preform manufacturing step AS1 is exhausted together with the exhaust gas without being added to the porous glass preform. In addition, even in the subsequent dehydration and consolidation step AS2, a part of germanium in the porous preform is volatilized due to heating at a high temperature, and is exhausted together with the exhaust gas.

Since germanium is expensive, it is desirable that germanium in the exhaust gas is recovered. Here, it can be considered to recover germanium from the exhaust gas exhausted in the porous preform manufacturing step AS1. However, in the porous preform manufacturing step AS1, a flow rate of the exhaust gas is extremely high, and the exhaust gas includes a large amount of solid matter, such as silica, other than germanium. Therefore, there is a concern that the size of a facility for recovering germanium increases or the recovery efficiency decreases.

Accordingly, in the method for recovering germanium according to the present embodiment, germanium is recovered from the exhaust gas exhausted in the dehydration and consolidation step AS2 of optical fiber preform manufacturing. More specifically the method for recovering germanium according to the present embodiment includes the first step of allowing the exhaust gas exhausted in the dehydration and consolidation step AS2 to pass through a separation device and separating germanium from the exhaust gas. The exhaust gas in the dehydration and consolidation step AS2 has a lower gas flow rate than the porous preform manufacturing step AS1. Therefore, germanium can be recovered by a small and inexpensive recovery facility. In addition, the amount of solid matter in the exhaust gas of the dehydration and consolidation step AS2 is small, and thus a decrease in recovery efficiency caused by accumulation of solid matter on the separation device is avoidable.

### First Aspect: Separation by Wet Collection Device

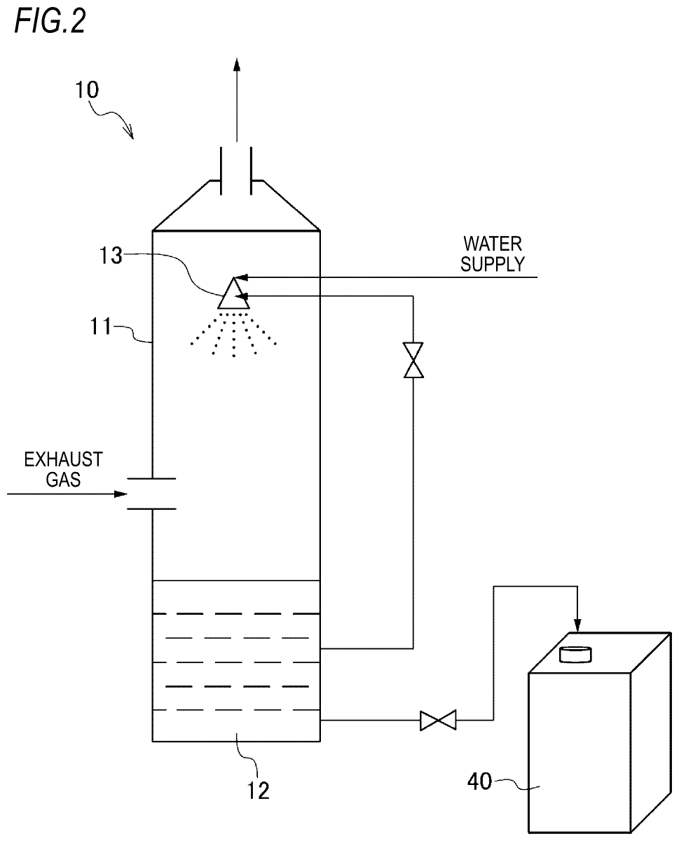

In a first aspect of the present embodiment, the separation device may be a wet collection device 10. FIG. 2 is a diagram schematically illustrating the first step where the wet collection device 10 is used. As the wet collection device 10, various scrubbers and the like can be adopted. The wet collection device 10 illustrated in FIG. 2 includes a cleaning tower 11, cleaning water 12, and a nozzle 13 that sprays the cleaning water 12. In the first step of the present aspect, first, the exhaust gas exhausted from the furnace tube where the dehydration and consolidation step AS2 is executed is introduced into the cleaning tower 11 of the wet collection device 10. Next, the cleaning water 12 is sprayed from the nozzle 13 provided on an upper side in the cleaning tower 11, and germanium in the exhaust gas that is a gas phase changes into the cleaning water 12 that is a liquid phase. As a result, germanium can be separated from the exhaust gas to be extracted into the cleaning water 12. The cleaning water 12 including germanium is supplied to a recovery tank 40 when a predetermined standard determined based on an operating time, a concentration, or the like is reached. The exhaust gas from which germanium is separated is supplied to an exhaust gas treatment device from the upper side of the cleaning tower 11, and is treated using a predetermined method (exhaust gas treatment step BS1).

The present aspect where the wet collection device 10 is used as the separation device can be suitably adopted for a case where the exhaust gas includes dehydration gas, for example, during the execution of the dehydration step or immediately after the end of the dehydration step. In the dehydration step, dehydration gas such as chlorine gas is supplied into the furnace tube. Therefore, for example, when germanium is separated from the exhaust gas in the dehydration step using an adsorbent, deterioration of the adsorbent progresses due to the dehydration gas in the exhaust gas, and the lifetime of the adsorbent decreases. Accordingly, when the exhaust gas includes the dehydration gas, by using the wet collection device as the separation device, germanium can be recovered while avoiding deterioration of the facility.

In the present aspect, a temperature of the cleaning water 12 is preferably 30° C. or higher and 80° C. or lower. When the temperature of the cleaning water 12 is in this range, the cleaning water 12 can include germanium at a high concentration, and costs such as a transport cost or a regeneration cost for reusing the recovered germanium can be reduced.

### Second Aspect: Separation by Dry Adsorption Device

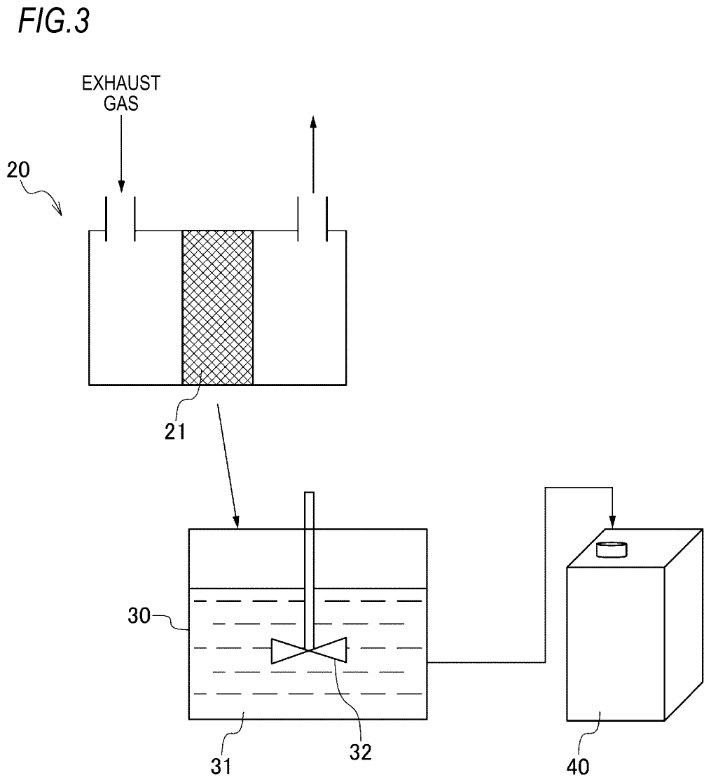

In a second aspect that is another aspect of the present embodiment, the separation device may be a dry adsorption device 20. FIG. 3 is a diagram schematically illustrating the first step in which the dry adsorption device 20 is used and a second step described below. The dry adsorption device 20 includes an adsorbent 21.

The adsorbent 21 is not particularly limited as long as it can adsorb germanium, and a zeolite-based adsorbent or activated carbon can be used. The shape of the adsorbent 21 is not particularly limited, and a pellet shape or a bead shape can be used. It is preferable that the adsorbent 21 has a pellet shape.

In the first step of the present aspect, first, the exhaust gas exhausted from the furnace tube where the dehydration and consolidation step AS2 is executed is introduced into the dry adsorption device 20. The introduced exhaust gas passes through the adsorbent 21. At this time, germanium in the exhaust gas is adsorbed to the adsorbent 21. As a result, germanium can be separated from the exhaust gas. The exhaust gas from which germanium is separated is supplied from the dry adsorption device to the exhaust gas treatment device, and is treated using a predetermined method (exhaust gas treatment step BS1).

The method for recovering germanium according to the present aspect where the dry adsorption device 20 is used further includes the second step of extracting germanium adsorbed to the adsorbent 21 into a liquid 31 in a mixing tank 30 after the first step. When germanium is extracted into the liquid 31 in the second step, the adsorbent 21 may be directly injected into the mixing tank 30 including the liquid 31, or after putting the adsorbent 21 into a resin mesh container, the mesh container may be injected into the mixing tank 30. By injecting the adsorbent 21 and subsequently stirring the liquid using a stirring blade 32 or the like, germanium can be sufficiently extracted into the liquid 31. As the liquid 31, for example, water is used. After extracting germanium, the adsorbent 21 is removed from the mixing tank 30 by sedimentation or by taking out the mesh container. The liquid 31 from which germanium is extracted is supplied to the recovery tank 40.

In the second step according to the present aspect, it is preferable that at least one of a pH and a temperature of the liquid 31 is adjusted, and germanium is extracted into the liquid 31. More specifically, it is preferable that the pH of the liquid 31 is adjusted to be 0 or more and 6 or less. By adjusting the liquid to be acidic, germanium can be efficiently extracted. In addition, it is preferable that the temperature of the liquid 31 is adjusted to be 30° C. or higher and 80° C. or lower. By adjusting the temperature of the liquid, the concentration of germanium in the liquid can be increased, and costs such as a transport cost or a regeneration cost for reusing the recovered germanium can be reduced.

The dry adsorption device has a higher degree of freedom for the facility than the wet collection device in that, for example, the installation is easy and the adsorption capacity can be selected. Accordingly, by using the dry adsorption device as the separation device, a reduction in the size of the device or a reduction in costs can be realized. However, when the exhaust gas is separated in the dehydration step as described above, it is preferable to use the wet collection device. A configuration of switching the introduction destination of the exhaust gas during the dehydration and consolidation step such that the wet collection device is used as the separation device during the execution of the dehydration step and the dry adsorption device is used as the separation device during the execution of the consolidation step may be adopted.

### Treatment of Germanium Extraction Liquid

Through the first step according to the aspect where the wet collection device is used or the second step where the dry adsorption device is used, the liquid into which germanium is extracted (hereinafter, referred to as the germanium extraction liquid) is obtained. The germanium extraction liquid is appropriately provided for an extraction liquid treatment S2, and germanium is recovered. In the germanium recovery method according to the present disclosure, a specific method of the extraction liquid treatment S2 is not particularly limited, and an example of the extraction liquid treatment S2 will be described below.

When a solid residue is produced in the germanium extraction liquid, a treatment of separating the germanium extraction liquid and the solid residue from each other in the extraction liquid treatment S2 may be executed. As the method of separating the germanium extraction liquid and the solid residue from each other, a method such as sedimentation, filtration under reduced pressure, or filtration under pressure can be adopted.

In the extraction liquid treatment S2, a treatment of depositing a germanium-containing compound from the germanium extraction liquid (hereinafter, referred to as the deposition treatment) may be executed. In the deposition treatment, by concentrating the germanium extraction liquid or by adding a metal salt to the germanium extraction liquid, the germanium-containing compound may be deposited from the germanium extraction liquid. In the deposition treatment, by concentrating the germanium extraction liquid or by adding a metal salt to the germanium extraction liquid for coprecipitation, the germanium-containing compound can be efficiently deposited by inexpensive means.

When the metal salt is added in the deposition treatment, a soluble metal salt that forms a complex oxide with germanium or an insoluble metal salt that adsorbs germanium may be added. When the soluble metal salt is added, germanium dissolved in the germanium extraction liquid can be recovered with a high yield as a complex oxide of germanium and the added metal. When the insoluble metal salt is added, germanium can be collected on the surface of the insoluble metal salt to deposit the germanium-containing compound, and germanium dissolved in the germanium extraction liquid can be recovered with a high yield.

When the metal salt is added in the deposition treatment, an alkali earth metal salt may be added. When the alkali earth metal salt is added, the germanium-containing compound can be suitably deposited, and germanium dissolved in the germanium extraction liquid can be recovered with a high yield. Examples of the alkali earth metal salt include magnesium chloride, magnesium sulfate, and calcium chloride. An addition amount of the alkali earth metal may be 0.8 equivalents or more and 3.0 equivalents or less with respect to 1 equivalent of germanium in the liquid. By adding the alkali earth metal salt in the above-described addition amount, the metal salt is not limited to a complex oxide including germanium and the alkali earth metal at an equivalent ratio of 1:1, and the formation of a complex oxide including a larger amount of the alkali earth metal in terms of the equivalent ratio can also be derived, and germanium dissolved in the germanium extraction liquid can be recovered with a high yield.

After the above-described deposition treatment, a treatment of separating the deposited germanium-containing compound and the liquid from each other (hereinafter, referred to as the solid-liquid separation treatment) may be executed. As the separation method, a method such as sedimentation, filtration under reduced pressure, or filtration under pressure can be adopted. The separated germanium-containing compound is recovered, and the separated liquid is treated as a wastewater as necessary.

The germanium-containing compound may be provided for a classification treatment of classifying the germanium-containing compound into a coarse particle component and a fine particle component. For the classification treatment, a thickener, a liquid cyclone, a centrifugal separator, or the like can be adopted. After classifying the germanium-containing compound into the coarse particle component and the fine particle component, the solid-liquid separation of the coarse particle component may be executed using the method such as sedimentation, filtration under reduced pressure, or filtration under pressure to recover the coarse particle component of the germanium-containing compound. The liquid including the fine particle component of the germanium-containing compound may return to the above-described deposition treatment and may be mixed with the germanium extraction liquid for cyclic use. By returning the classified fine particle component of the germanium-containing compound to the deposition treatment for use, the fine particle component functions as a seed crystal when the germanium-containing compound is deposited. As a result, the deposition of the germanium compound can be induced, and germanium dissolved in the germanium extraction liquid can be recovered with a high yield.

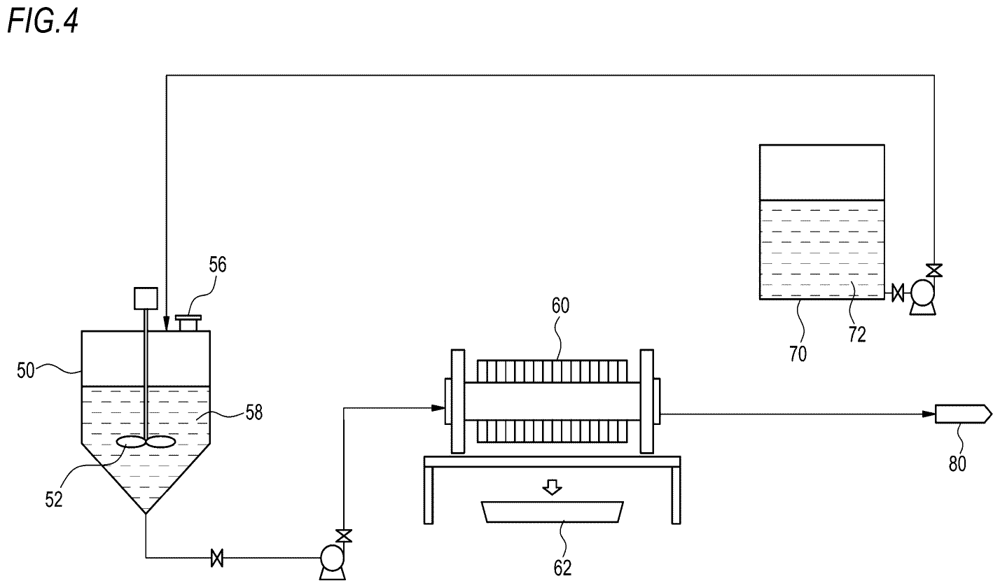

Here, one aspect of the deposition treatment and the solid-liquid separation treatment will be described with reference to FIG. 4. FIG. 4 is a diagram schematically illustrating the deposition treatment and the solid-liquid separation treatment. FIG. 4 illustrates a deposition tank 50 for executing the deposition treatment, a filter press 60 for executing the solid-liquid separation treatment, a fine particle component-containing liquid stock tank 70 for stocking a fine particle component-containing liquid 72 that is a liquid including the classified fine particle component of the germanium-containing compound, and a wastewater treatment facility 80 for executing the wastewater treatment of the subsequent stage. The fine particle component-containing liquid stock tank 70, the deposition tank 50, the filter press 60, and the wastewater treatment facility 80 are connected through a pipe for liquid supply as illustrated in FIG. 4.

The deposition tank 50 includes a stirring blade 52, a germanium extraction liquid inlet (not illustrated), and a reagent inlet 56. In the deposition treatment, the germanium extraction liquid is injected into the deposition tank 50 from the germanium extraction liquid inlet. By injecting the metal salt such as magnesium chloride into the germanium extraction liquid through the reagent inlet 56, a germanium-containing compound 62 is deposited, and a slurry 58 including the germanium-containing compound 62 is prepared.

In the solid-liquid separation treatment, the slurry 58 prepared in the deposition tank 50 is filtered under pressure by the filter press 60. As a result, the germanium-containing compound 62 and the liquid can be separated to recover the germanium-containing compound 62. The separated liquid is transported to the wastewater treatment facility 80 as necessary. Before transporting the slurry 58 from the deposition tank 50 to the filter press 60, the classification treatment may be performed to classify the germanium-containing compound into the coarse particle component and the fine particle component. The liquid including the coarse particle component of the germanium-containing compound 62 may be transported to the filter press 60 for the filtration under pressure, and the liquid (fine particle component-containing liquid 72) including the fine particle component of the germanium-containing compound 62 may be stocked in the fine particle component-containing liquid stock tank 70. In the deposition treatment, the fine particle component-containing liquid 72 may be supplied to the deposition tank 50 from the fine particle component-containing liquid stock tank 70 such that the fine particle component is utilized as a seed crystal of the germanium-containing compound.

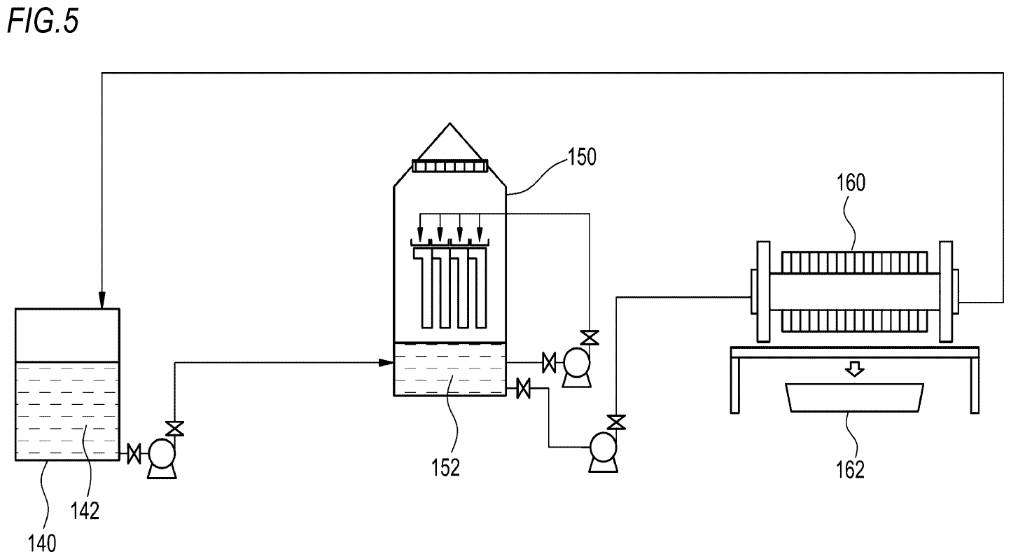

Next, another aspect of the deposition treatment and the solid-liquid separation treatment will be described with reference to FIG. 5. FIG. 5 is a diagram schematically illustrating the deposition treatment and the solid-liquid separation treatment. FIG. 5 illustrates a germanium extraction liquid stock tank 140 for stocking a germanium extraction liquid 142, an evaporator 150 for executing the deposition treatment, and a filter press 160 for executing the solid-liquid separation treatment. The germanium extraction liquid stock tank 140, the evaporator 150, and the filter press 160 are connected through a pipe for liquid supply as illustrated in FIG. 5.

The evaporator 150 receives the germanium extraction liquid 142 from the germanium extraction liquid stock tank 140, evaporates the liquid to prepare a concentrated liquid 152, and deposits a germanium-containing compound 162 (deposition treatment). By transporting the liquid including the deposited germanium-containing compound 162 to the filter press 160 and separating the germanium-containing compound 162 and the liquid from each other, the germanium-containing compound 162 can be recovered (solid-liquid separation treatment). The liquid separated in the solid-liquid separation treatment may return to the germanium extraction liquid stock tank 140.

### EXAMPLES

Hereinafter, Examples of the germanium recovery method according to the present disclosure will be described. The present disclosure is not limited to these Examples.

### Example 1: Separation by Wet Collection Device

Using a wet collection device, germanium in exhaust gas in a dehydration and consolidation step of a porous preform was recovered. As the wet collection device, a bubbling type scrubber was used. A pipe of exhaust gas exhausted from a furnace tube for manufacturing an optical fiber preform was connected to the scrubber to manufacture an optical fiber preform. In order to selectively treat exhaust gas including germanium in the exhaust gas exhausted in the manufacturing step, a valve was controlled such that the exhaust gas was introduced into the scrubber only when the porous preform was heated at a high temperature in the dehydration and consolidation step.

After allowing 1000 liters of exhaust gas produced in the dehydration and consolidation step to pass through the scrubber, cleaning water in the scrubber was taken out. 180 mg (in terms of the element) of germanium was recovered from the cleaning water that was taken out.

### Example 2: Separation by Dry Adsorption Device

Using a dry adsorption device including an adsorbent, germanium in exhaust gas was separated in a consolidation step. As the adsorbent, 60 kg of a zeolite-based adsorbent was used. A pipe of exhaust gas exhausted from a furnace tube for manufacturing an optical fiber preform was connected to the dry adsorption device to manufacture an optical fiber preform. In order to selectively treat the exhaust gas including germanium and to prevent deterioration of the adsorbent, a valve was controlled such that the exhaust gas was introduced into the dry adsorption device only in the consolidation step.

When the adsorbent of the dry adsorption device was taken out to analyze the components after manufacturing optical fiber preforms for one month, it was found that 200 g (in terms of the element) of germanium was able to be separated.

As can be seen from the above-described results of Examples, in the method for recovering germanium according to the present disclosure, germanium can be efficiently and inexpensively recovered from exhaust gas in a dehydration and consolidation step of optical fiber preform manufacturing.

1. A method for recovering germanium from exhaust gas in a manufacturing step of an optical fiber preform, the method comprising:
a first step of allowing the exhaust gas to pass through a separation device and separating germanium from the exhaust gas,
wherein the exhaust gas is gas exhausted in a dehydration and consolidation step of optical fiber preform manufacturing.

2. The method for recovering germanium according to claim 1,
wherein the separation device is a wet collection device, and
in the first step, the exhaust gas is allowed to pass through the wet collection device to extract germanium into a liquid.

3. The method for recovering germanium according to claim 2,
wherein in the first step, a temperature of the liquid used for extracting the germanium is 30° C. or higher and 80° C. or lower.

4. The method for recovering germanium according to claim 1,
wherein the separation device is a dry adsorption device including an adsorbent,
in the first step, the germanium is adsorbed to the adsorbent, and
the method further comprises a second step of extracting the germanium adsorbed to the adsorbent into a liquid after the first step.

5. The method for recovering germanium according to claim 4,
wherein in the second step, at least one of a pH and a temperature of the liquid is adjusted, and germanium is extracted into the liquid.

6. The method for recovering germanium according to claim 5,
wherein in the second step, the pH of the liquid is adjusted to be 0 or more and 6 or less.

7. The method for recovering germanium according to claim 5,
wherein in the second step, the temperature of the liquid used for extracting the germanium is 30° C. or higher and 80° C. or lower.

8. The method for recovering germanium according to claim 6,
wherein in the second step, the temperature of the liquid used for extracting the germanium is 30° C. or higher and 80° C. or lower.
